(19) United States
(12) Patent Application Publication
(10) Pub. No.: US 2026/0107271 A1
(43) Pub. Date: Apr. 16, 2026

(54) COMMUNICATION APPARATUS, COMMUNICATION METHOD, AND STORAGE MEDIUM

(71) Applicant: CANON KABUSHIKI KAISHA, Tokyo (JP)

(72) Inventor: HIROHIKO INOHIZA, Rennes (FR)

(21) Appl. No.: 19/418,674

(22) Filed: Dec. 12, 2025

Related U.S. Application Data
(63) Continuation of application No. PCT/JP2024/021594, filed on Jun. 14, 2024.

(30) Foreign Application Priority Data
Jun. 21, 2023 (JP) 2023-102039

(51) Int. Cl. H04W 72/121; H04W 76/15; H04W 84/12

(52) U.S. Cl. CPC H04W 72/121; H04W 76/15; H04W 84/12

(57) ABSTRACT

A communication apparatus includes at least one memory that stores a set of instructions, and at least one processor that executes the instructions, the instructions, when executed, causing the communication apparatus to perform operations including receiving, from an external apparatus, a first wireless frame whose physical layer (PHY) preamble includes first group identification information for identifying a group for enabling a plurality of other communication apparatuses to perform transmission in a coordinated manner, and processing the first wireless frame.

### CROSS-REFERENCE TO RELATED APPLICATIONS

This application is a Continuation of International Patent Application No. PCT/JP2024/021594, filed Jun. 14, 2024, which claims the benefit of Japanese Patent Application No. 2023-102039, filed Jun. 21, 2023, both of which are hereby incorporated by reference herein in their entirety.

### BACKGROUND

### Field of the Technology

The present disclosure relates to a communication control technique in a wireless local area network (LAN).

### Description of the Related Art

In recent years, with the increase in the amount of data being communicated, the development of communication technologies such as wireless local area network (LAN) has been progressing. The Institute of Electrical and Electronics Engineers (IEEE) 802.11 standard series is known as a major communication standard for wireless LAN. The IEEE 802.11 standard series includes standards such as IEEE 802.11a/b/g/n/ac/ax/be and the like (Japanese Patent Laid-Open No. 2018-50133).

For example, the IEEE 802.11be standard has discussed Multi-Link communication, in which a single access point (AP) establishes a plurality of links with a single station (STA) via a plurality of different frequency channels and perform communication in parallel. Two or more links may be selected from the same frequency band (any of the 2.4 GHz band, 3.6 GHz band, 4.9 GHz band, 5 GHz, and 6 GHz band) or they may be selected from different frequency bands. An AP and a STA that support Multi-Link are referred to as an AP Multi-Link device (MLD) and an STA MLD, respectively.

In the successor standards to the IEEE 802.11be standard, methods for improving usability by using Multi-AP communication are being studied.

For example, there is a distributed multiple input multiple output (MIMO) technology based on a technique referred to as MIMO, which uses a plurality of transmission and reception antennas simultaneously on the same channel. In distributed MIMO, in an environment in which a plurality of APs and a plurality of STAs exist, the APs form a group to share information about a communication state and the state of each AP among them, and data is transmitted from the APs to the STAs at the same timing. By having the plurality of APs perform coordinated transmission, it is possible to increase the number of spatial streams compared to the case of a single AP, and thus the improvement in throughput can be expected.

Another example is a technique referred to as coordinated beamforming. When an AP transmits data to a STA within its basic service set (BSS), an antenna pattern is used in which the antenna gain is high in the direction of the STA to which the data is to be transmitted and low in the directions of STAs within the BSSs of other APs. Interference between BSSs can be reduced by configuring antenna patterns, adjusting transmission power, and performing scheduling among the plurality of APs based on environment information such as the positions of the STAs.

Another example is a technique in which a plurality of APs transmit data to an STA at different timings by time division, thereby improving the reception quality at the STA through the effects of time diversity and spatial diversity.

Such a communication technique in which a plurality of APs form a group and operate in a coordinated manner is referred to as Multi-AP communication, and the APs are classified into a single Coordinator AP that manages all APs and Coordinated APs that operate under the control of the Coordinator AP.

It can be useful for a communication apparatus to recognize group identification information used for a plurality of other communication apparatuses to perform transmission in a coordinated manner. For example, in Multi-AP communication, it is conceivable that a plurality of access points (APs) forms a group and transmit data to a single station (STA) in a coordinated manner. However, there has been no mechanism for a communication apparatus to recognize group identification information used for enabling a plurality of other communication apparatuses to perform transmission in a coordinated manner.

### SUMMARY

The present disclosure is directed to the provision of a technique that enables a communication apparatus to recognize group identification information for allowing a plurality of other communication apparatuses to perform coordinated transmission.

According to an aspect of the present disclosure, a communication apparatus includes at least one memory that stores a set of instructions, and at least one processor that executes the instructions, the instructions, when executed, causing the communication apparatus to perform operations including receiving, from an external apparatus, a first wireless frame whose physical layer (PHY) preamble includes first group identification information for identifying a group for enabling a plurality of other communication apparatuses to perform transmission in a coordinated manner, and processing the first wireless frame.

Features of the present disclosure will become apparent from the following description of embodiments with reference to the attached drawings.

### BRIEF DESCRIPTION OF THE DRAWINGS

FIG. 1 is a diagram illustrating an example of a network configuration.

FIG. 2 is a diagram illustrating an example of a hardware configuration of a communication apparatus.

FIG. 3 is a diagram illustrating an example of a functional configuration of a communication apparatus.

FIG. 4 is a sequence diagram illustrating an example of processing performed by a communication apparatus.

FIG. 5 is a diagram illustrating an example of a wireless frame structure.

FIG. 6 is a flowchart diagram illustrating an example of processing performed by communication apparatuses.

FIG. 7 is a flowchart diagram illustrating an example of processing performed by communication apparatuses.

### DESCRIPTION OF THE EMBODIMENTS

The embodiments will now be described in detail with reference to the accompanying drawings. It should be noted that the embodiments described below do not limit the invention as defined in the claims. Although a plurality of features is described in the embodiments, not all of these features are essential to the invention, and the features may be combined arbitrarily. Furthermore, in the accompanying drawings, identical or similar components are denoted by the same reference numerals, and redundant descriptions are omitted.

### (Network Configuration)

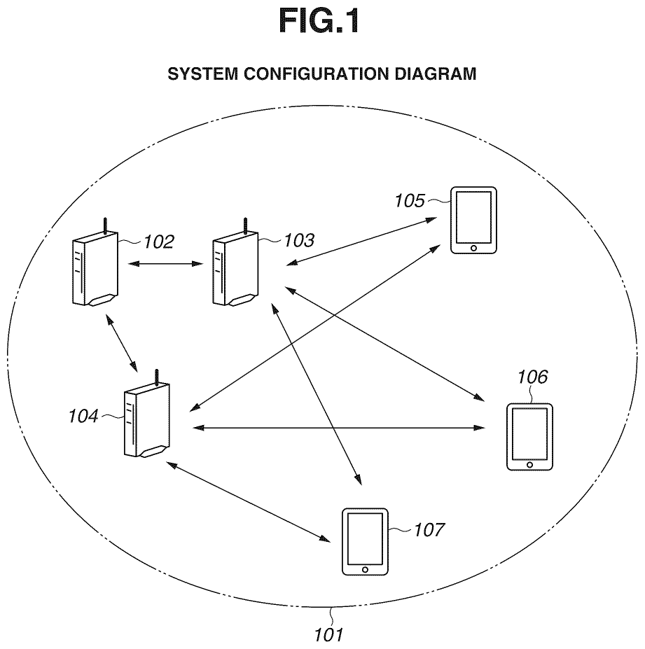

FIG. 1 is a diagram illustrating an example of the configuration of a wireless communication network according to one embodiment. The wireless communication network is configured to include access points (APs) (communication apparatuses 102, 103, and 104, hereinbelow, referred to as AP 102, AP 103, and AP 104) and terminals (communication apparatuses 105, 106, and 107, hereinbelow, referred to as a station (STA) 105, STA 106, and STA 107). In the following description, in a case where a specific apparatus is not referred to, the term “AP” may be used to refer to an access point without reference numerals, and the term “STA” may be used to refer to a station without reference numerals.

Each of the APs 102 to 104 and the STAs 105 to 107 is configured to communicate wireless frames in compliance with a standard that targets a maximum transmission speed exceeding 90-100 Gbps, which is a successor standard to the Institute of Electrical and Electronics Engineers (IEEE) 802.11be standard that targets a maximum transmission speed of 46.08 Gbps.

In the successor standard to the IEEE 802.11be standard, the main feature includes support for high-reliability communication and low-latency transmission and AP coordination. Based on the above description, according to the present embodiment, the successor standard to the IEEE 802.11be standard, which targets the maximum transmission speed exceeding 90 to 100 Gbps, is also referred to as IEEE 802.11 Ultra High Reliability (UHR). Further, a wireless frame to be communicated under this successor standard is also referred to as a UHR Physical Layer Convergence Protocol (PLCP) Protocol Data Unit (PPDU).

The names “IEEE 802.11 UHR” and “UHR standard” are provided for convenience based on the objectives to be achieved by the successor standard and its key features, and the final name may differ once the standard is fully established. On the other hand, it is to be understood that the present specification and the appended claims are essentially applicable to any successor standard to the IEEE 802.11be standard that can support a function of enabling a plurality of APs to cooperate in performing a process of communicating data with STAs.

Each communication apparatus can perform communication in frequency bands such as a 2.4 GHz band, a 3.6 GHz band, a 5 GHz band, and a 6 GHz band, as well as millimeter-wave bands including a 45 GHz band and a 60 GHz band. The frequency bands used by each communication apparatus are not limited to these, and different frequency bands, such as a Sub1 GHz band, may also be used. Further, the APs 102 to 104 and the STAs 105 to 107 can communicate using bandwidths of 20 MHz, 40 MHz, 80 MHz, 160 MHz, 320 MHz, 540 MHz, 640 MHz, 1080 MHz, and 2160 MHz. The bandwidths used by each communication apparatus are not limited to these, and different bandwidths, such as 240 MHz and 4 MHz, may also be used.

By executing Orthogonal Frequency Division Multiple Access (OFDMA) communication compliant with the IEEE 802.11 standard, the APs 102 to 104 and the STAs 105 to 107 can realize multi-user (MU) communication in which signals from a plurality of users are multiplexed. In OFDMA communication, a portion of the divided frequency band (resource unit (RU)) is allocated to each STA so that they do not overlap, and the carrier waves of the respective STAs are orthogonal. Thus, the AP can communicate with a plurality of STAs in parallel within a specified bandwidth.

Although each communication apparatus is assumed to support the IEEE 802.11 UHR standard, and it may additionally support a legacy standard that precedes the IEEE802.11 UHR standard. Specifically, each communication apparatus may support at least one of the IEEE 802.11a/b/g/n/ac/ax/be standards. In addition to the IEEE 802.11 series standards, each communication apparatus may also support other communication standards such as Bluetooth®, Near Field Communication (NFC), Ultra Wide Band (UWB), ZigBee, Multi Band OFDM Alliance (MBOA), and the like. The UWB includes wireless Universal Serial Bus (USB), Wireless 1394, WiMedia Network (WiNET), and the like. Each communication apparatus may also support wired communication standards, such as a wired local area network (LAN). Specific examples of the APs 102 to 104 include, but are not limited to, wireless LAN routers and personal computers (PCs). The APs 102 to 104 may also be information processing apparatuses such as wireless chips that can execute wireless communication compliant with the IEEE 802.11 UHR standard. Specific examples of the STAs 105 to 107 include, but are not limited to, cameras, tablets, smartphones, PCs, mobile phones, video cameras, headsets, and the like. The STAs 105 to 107 may also be information processing apparatuses such as wireless chips that can execute wireless communication compliant with the IEEE 802.11 UHR standard.

FIG. 1 illustrates an example of a wireless communication network that include three APs and three STAs, but the number of these communication apparatuses may be two or less, or four or more. In FIG. 1, a circle 101 indicates a communicable range of the network formed by the APs 102 to 104. The communicable range may cover a wider area or may cover only a narrower area.

According to the present embodiment, each of the APs 102 to 104 establishes a basic service set (BSS), and each BSS has a different BSS Color. The BSS Color serves as an identification (ID) for identifying the BSS. It is assumed that the service set identifiers (SSID) indicated by the APs 102 to 104 in each BSS are common. The SSID is an identifier for identifying the access point.

According to the present embodiment, the APs 103 and 104 can receive a signal transmitted by the AP 102, and the AP 102 can receive signals transmitted by the APs 103 and 104. However, the connection configuration is not particularly limited, and the AP 102 may be connected to each of the APs 103 and 104 by wire or wirelessly. The APs 103 and 104 may or may not be able to transmit and receive each other's signals. The APs 102 to 104 are capable of performing Multi-AP communication in accordance with the IEEE 802.11 UHR standard. In other words, it is assumed that the APs 102 to 104 support a configuration in which a plurality of APs cooperates to communicate with a single common STA, as specified in the IEEE 802.11 UHR standard. For example, the STA 105 can transmit and receive wireless frames in parallel with the APs 103 and 104 that operate in a coordinated manner. The STA 105, for example, may include a plurality of wireless LAN control units and may be configured transmit and receive wireless frames with a plurality of APs using different wireless channels. The STA 105 may also include a single physical control unit that is capable of processing a plurality of frames received in parallel via a plurality of wireless channels. In other words, the STA 105 has a configuration that allows logical parallel processing of a plurality of wireless communications using one or more physical control units.

Here, APs such as the APs 103 and 104 that are controlled by a Coordinator AP and directly transmit and receive signals with each STA are referred to as Coordinated APs. Further, an AP such as the AP 102 that can transmit and receive wireless frames with each STA at least indirectly by issuing instructions to the APs 103 and 104 is referred to as a Coordinator AP. The Coordinator AP may also be referred to as a Sharing AP since it shares wireless medium resources with other APs to execute coordinated operations. Similarly, the Coordinated AP is sometimes referred to as a Shared AP. The Coordinator AP may directly transmit and receive signals with the STA 105. For example, the AP 102 can operate as both a Coordinator AP and a Coordinated AP. In this case, for example, while transmitting and receiving wireless frames with the STA 105, the AP 102 may issue an instruction to the AP 103 or 104 to transmit and receive wireless frames with the STA. In a case where the Coordinator AP causes a Coordinated AP to transmit a wireless frame, the Coordinator AP can transmit transmission target data to the Coordinated AP. However, the configuration is not limited to this, and the Coordinated AP may directly acquire the transmission target data from, for example, the Internet. Further, the Coordinator AP can receive, from the Coordinated AP, data that the Coordinated AP receives from the STA. However, the Coordinated AP may transfer the data received from the STA to a communication partner device of the STA without transferring it to the Coordinator AP.

Any AP within the same network can operate as a Coordinator AP, and any one of the APs can be determined to operate as a Coordinator AP based on some criteria. The Coordinator AP may perform only the role of a Coordinator AP, such as transmitting an instruction to each AP, without operating as an AP that transmits Beacon frames or the like. Each AP may include a plurality of wireless LAN control units and operate as a plurality of Coordinated APs. The Coordinator AP may be implemented as a logical function, and a single physical AP may operate as a Coordinator AP while operating as one or more Coordinated APs.

### (Configurations of AP and STA)

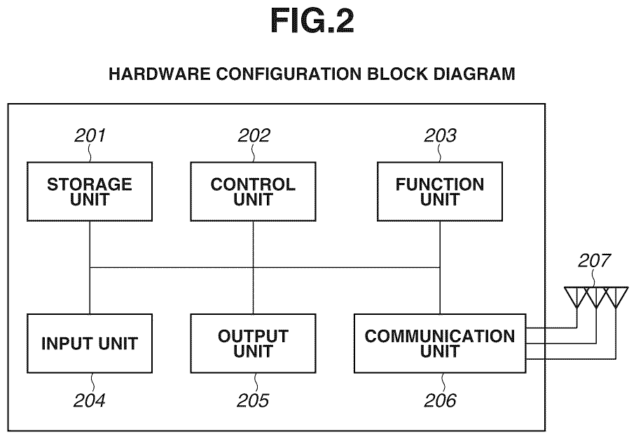

FIG. 2 is a diagram illustrating an example of a hardware configuration of the APs 102 to 104 according to the present embodiment. Each of the APs 102 to 104 includes a storage unit 201, a control unit 202, a functional unit 203, an input unit 204, an output unit 205, a communication unit 206, and an antenna 207. There may be a plurality of antennas.

The storage unit 201 is configured with one or more memories such as a read-only memory (ROM), a random access memory (RAM), and the like and stores a computer program for performing various operations described below and various types of information such as communication parameters for wireless communication and the like. In addition to the memories such as ROM, RAM, and the like, the storage unit 201 may be a storage medium such as a flexible disk, a hard disk, an optical disk, a magneto-optical disk, a compact disk ROM (CD-ROM), a CD-readable (CD-R), a magnetic tape, a non-volatile memory card, a digital versatile disc (DVD), and the like. The storage unit 201 may include a plurality of memories and the like.

The control unit 202 is configured with one or more processors such as a central processing unit (CPU), a micro processing unit (MPU), and the like and controls the entire AP 102, 103 or 104 by executing a computer program stored in the storage unit 201. The control unit 202 may control the entire AP 102, 103 or 104 in coordination with a computer program stored in the storage unit 201 and an operating system (OS). The control unit 202 also generates data and signals (wireless frames) to be transmitted in communication with other communication apparatuses. The control unit 202 may also include a plurality of processors, such as multi-core processors, and control the entire AP 102, 103 or 104 using the plurality of processors.

The control unit 202 also controls the functional unit 203 to execute predetermined processing such as wireless communication, imaging, printing, projecting, and the like. The functional unit 203 is hardware for the AP 102, 103 or 104 to execute the predetermined processing. If the functional unit 203 is a printer, it prints image data acquired via the communication unit 206. If the functional unit 203 is a scanner, it transmits image data generated by scanning to an external apparatus via the communication unit 206. Furthermore, if the functional unit 203 is a camera, it transmits captured image data to an external apparatus via the communication unit 206.

The input unit 204 receives various operations from a user. The input unit 204 is configured with, for example, a touch panel, a hard key, a button, or the like.

The output unit 205 performs various outputs to a user via a monitor screen or a loudspeaker.

Here, the output from the output unit 205 may include display on the monitor screen, an audio output through the loudspeaker, a vibration output, and the like. The input unit 204 and the output unit 205 may be implemented as a single module, such as a touch panel. Further, the input unit 204 and the output unit 205 may be integrated with each of the APs 102 to 104 or may be separated from them.

The communication unit 206 controls wireless communication compliant with the IEEE 802.11 UHR standard.

The communication unit 206 may also control wireless communication compliant with other IEEE 802.11 series standards in addition to the IEEE 802.11 UHR standard and control wired communication such as wired LAN and the like. The communication unit 206 controls the antenna 207 to transmit and receive signals generated by the control unit 202 for wireless communication.

In a case where the APs 102 to 104 support the NFC standard, Bluetooth® standard, and the like in addition to the IEEE 802.11 UHR standard, they may control wireless communication compliant with these communication standards. In a case where the APs 102 to 104 are capable of executing wireless communication compliant with a plurality of communication standards, they may each include separate communication units and antennas each corresponding to a different communication standard. The APs 102 to 104 communicate data such as image data, document data, video data, and the like with each STA via the communication unit 206. The antenna 207 may be configured as a separate component from the communication unit 206 or may be configured as a single module together with the communication unit 206.

The antenna 207 is capable of performing communication in 2.4 GHz band, 5 GHz band, 6 GHz band, 45 GHz band, and 60 GHz band. According to the present embodiment, the APs 102 to 104 are assumed to include two antennas, but they may also include three antennas. Alternatively, the APs 102 to 104 may include different antennas for each frequency band. Further, in a case where the APs 102 to 104 include a plurality of antennas, they may include the communication units 206 corresponding to each antenna.

The STAs 105 to 107 have a hardware configuration similar to that of the APs 102 to 104.

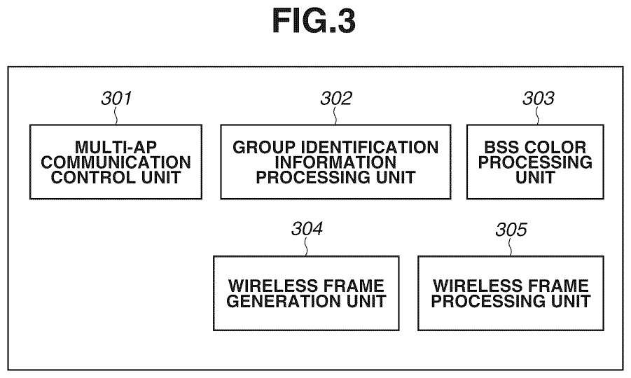

FIG. 3 is a block diagram illustrating a functional configuration of the APs 102 to 104 and the STAs 105 to 107 according to the present embodiment. The functional configuration illustrated in FIG. 3 is realized by, for example, one or more processors executing programs stored in one or more memories.

The APs 102 to 104 and the STAs 105 to 107 are each configured with a Multi-AP communication control unit 301, a group identification information processing unit 302, a BSS color processing unit 303, a wireless frame generation unit 304, and a wireless frame processing unit 305.

The Multi-AP communication control unit 301 is a functional unit that performs processing for forming a group for the APs 102 to 104 to perform Multi-AP communication, processing for adding and deleting a participating AP, processing for sharing network information related to Multi-AP communication, and control of communication between APs. The Multi-AP communication control unit 301 also performs control for the STAs 105 to 107 to establish a connection for Multi-AP communication and the like.

The group identification information processing unit 302 is a functional unit that extracts group identification information to be shared after the APs 102 to 104 perform processing for forming the group for Multi-AP communication and manages the group identification information of wireless frames to be transmitted. The group identification information processing unit 302 is also a functional unit that, when the STAs 105 to 107 establish a connection to participate in Multi-AP communication, manages the group identification information acquired from the connected AP and determines whether to process or discard the wireless frames based on the group identification information included in the wireless frames received from the APs during Multi-AP communication.

The BSS color processing unit 303 is a functional unit that sets BSS Color associated with the BSS configured by each of the APs 102 to 104. The BSS color processing unit 303 is also a functional unit that acquires BSS Color included in the wireless frames received by the STAs 105 to 107 and determines whether to process or discard the received wireless frames when Multi-AP communication is not being performed.

The wireless frame generation unit 304 is a functional unit that generates wireless frames to be exchanged in communicating with a connected STA or another AP. The APs 102 to 104 add the BSS Color to the generated wireless frames and add the group identification information to the wireless frames generated when performing Multi-AP communication.

The wireless frame processing unit 305 transmits wireless frames including Beacon frames and data frames generated by the wireless frame generation unit 304 and receives wireless frames from the communication partner device.

### (Processing Flow)

Next, several examples will be described, including flows of processing executed by the above-described APs and STAs, a sequence in a wireless communication system, and the like.

### First Example

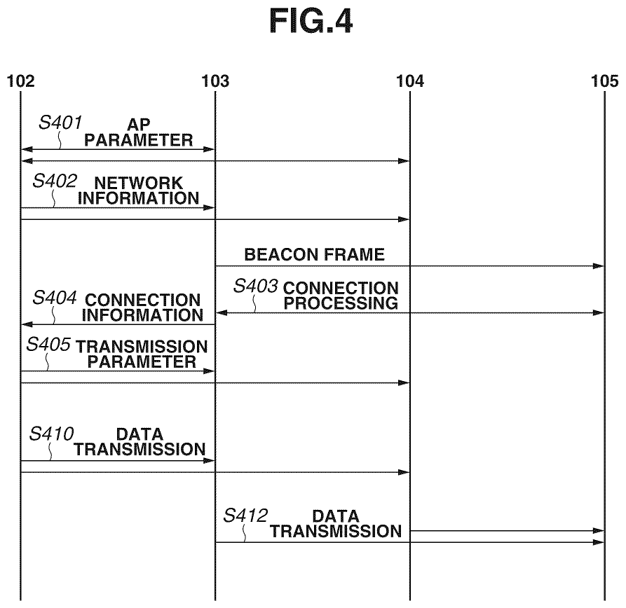

FIG. 4 is a sequence diagram illustrating an example of processing in which the AP 102 operates as the Coordinator AP, and the APs 103 and 104, which are Coordinated APs, transmit data to the STA 105 in a coordinated manner.

In the present processing, first in step S401, it is determined which AP among the APs 102 to 104 operates as the Coordinator AP (and which APs operate as Coordinated APs). For example, the APs 102 to 104 exchange parameters as APs therebetween, compare the parameters, and determine the AP that operates as the Coordinator AP. In the present processing example, it is assumed that the AP 102 is determined to operate as the Coordinator AP, and the APs 103 and 104 are determined to operate as Coordinated APs. Subsequently, the AP 102 operating as the Coordinator AP notifies the APs 103 and 104 operating as Coordinated APs of network information such as group identification information for a plurality of APs, SSID, BSSID, and the like. Then, in step S402, the APs 103 and 104 receive the notified network information. In a case where the roles of the Coordinator AP and the Coordinated APs are determined in advance, a part of the processing in steps S401 and S402 may be omitted.

The AP 103 transmits a Beacon frame according to the notified information. The Beacon frame includes information indicating that Multi-AP communication can be performed on the connected STA. The AP described here includes logical APs, and a single AP can include, for example, two logical APs, one operating in the 2.4 GHz band and the other operating in the 5 GHz band. In other words, data transmission and reception by a plurality of APs can include data transmission and reception by a single physical AP that can operate as a plurality of logical APs. For example, the AP 103 adds a Multi-AP information element to the Beacon frame and transmits the Beacon frame including information such as the group identification information of the plurality of APs, SSID, BSSID, an operating wireless channel, and the like used by the plurality of Coordinated APs that are capable of operating in a coordinated manner. A method and format for storing these pieces of information are not limited to this, and the AP 103 may store similar information in a similar format and transmit it. The information indicating that Multi-AP communication can be performed on the connected STA may be included in a probe response frame or other wireless frames. In step S403, upon receiving the Beacon frame, the STA 105 performs processing for connecting to at least one of the plurality of Coordinated APs based on the information included in the Beacon frame. The connection processing performed here includes processing such as Authentication and Association specified in the IEEE 802.11 standard series. For example, the STA 105 adds a Multi-AP Information Element to an Association Request frame to be transmitted to indicate a request for Multi-AP communication. The AP 103, upon receiving the Association Request frame, transmits an Association Response frame as a response. The Association Response frame may include the group identification information for the plurality of APs that perform Multi-AP communication with the connected STA. In a case where the AP 103 enters a connected state with the STA 105, in step S404, the AP 103 notifies the Coordinator AP that it enters a connected state with the STA, together with connection parameters. At this time, if a single physical AP enters the connected state with the STAs as two logical APs, it may notify the Coordinator AP of this state. In FIG. 4, only the AP 103 is in a connected state with the STA 105, but the AP 104 can also transmit a Beacon frame to connect to the STA 105 and notify the Coordinator AP (AP 102) that it enters a connected state. However, this is not limited to such a case, and for example, the STA may enter a connected state only one of the plurality of Coordinated APs. In this case, for example, the wireless frame transmitted from another Coordinated AP that is not in a connected state can be treated by the STA as a wireless frame from the Coordinated AP that is in a connected state. Even if the STA is in a connected state with only one of the plurality of Coordinated APs, the STA may be configured to recognize that the transmitting Coordinated AP differs for each wireless frame received from the Coordinated APs. According to the present example, by decoding the physical layer (PHY) preamble of the wireless frame, it is possible to recognize that signals are transmitted from the plurality of Coordinated APs (a Multi-AP coordination system is configured) based on the group identification information for the plurality of APs.

The Coordinator AP manages the connection parameters of the Coordinated APs that have entered a connected state with the STA, determines a transmission parameter based on the information, and allocates subsequent transmission data. In step S405, the information about the transmission parameter determined by the Coordinator AP is notified to the Coordinated APs, and the APs 103 and 104 set their own transmission parameters based on the notified information. The connection parameter may include information about the transmission rate and error rate of each connection. For example, the Coordinator AP can allocate more transmission data to a Coordinated AP that has a connection with a high transmission rate and less transmission data to a Coordinated AP that has a connection with a low transmission rate. Accordingly, each Coordinated AP can efficiently execute data transmission to the STA. The connection parameter may be periodically updated by each Coordinated AP to reflect the current connection status and notified to the Coordinator AP. Subsequently, if the Coordinated AP receives the transmission data for the STA from the Coordinator AP in step S410, it transmits the received data to the STA in step S412. At this time, the PHY preamble of the wireless frame for the data transmitted by each of the APs 103 and 104 includes group identification information for the plurality of APs set to the same value. The STA 105 compares the group identification information for the plurality of APs acquired from the AP 103, with which the connection is established, for performing Multi-AP communication for the STA 105 with the group identification information of the plurality of APs included in the PHY preamble of the wireless frame received in step S412, processes the received wireless frame if they match and discards the received wireless frame if they do not match. Thus, even if the value of the BSS Color of the wireless frame received from the AP 104 is different from the value of the BSS Color of the AP 103, the STA 105 processes the wireless frame received from the AP 104 without discarding it.

Such parallel transmission of data from the plurality of Coordinated APs to a single STA can be performed, for example, by transmitting a trigger frame for triggering transmission from the Coordinator AP to the Coordinated APs after the Coordinator AP has notified the Coordinated APs of the transmission target data. In other words, once preparation of the transmission target data is completed, the Coordinated APs simultaneously transmit the data to the STA based on receiving the trigger frame from the Coordinator AP. When the transmission target data is transmitted from the Coordinator AP to the Coordinated APs, information instructing the transmission timing of the data may be notified to the Coordinated APs together with the transmission target data. In this case, the plurality of Coordinated APs can transmit the transmission target data to the STA in parallel by transmitting the data at the instructed transmission timing.

On the other hand, if a Coordinated AP receives the data from the STA, it transmits the received data to the Coordinator AP. The order of these data transmissions and receptions is merely an example, and data may be transmitted and received in modes other than that illustrated in the drawing. For example, data reception from the STA may be performed before data transmission to the STA.

### (Wireless Frame Structure)

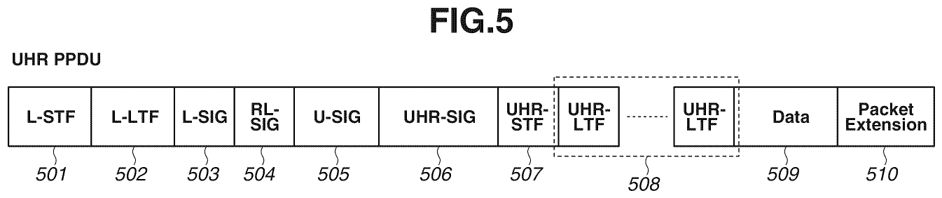

FIG. 5 is a diagram illustrating an example of a PPDU specified in the IEEE 802.11 UHR standard and transmitted in the present example.

A UHR PPDU includes fields such as a Short Training Field (STF), a Long Training Field (LTF), and a Signal Field (SIG). As illustrated in FIG. 5, the beginning of the PPDU includes a Legacy (L)-STF 501, an L-LTF 502, and an L-SIG 503 to ensure backward compatibility with the IEEE 802.11a/b/g/n/ax standards. The L-LTF is placed immediately after the L-STF, and the L-SIG is placed immediately after the L-LTF. The configuration illustrated in FIG. 5 further includes a repeated L-SIG (RL-SIG) 504 placed immediately after the L-SIG. In the RL-SIG, the contents of the L-SIG are repeatedly transmitted. The RL-SIG enables the receiver to recognize that the PPDU is compliant with standards subsequent to the IEEE 802.11ax standard and may be omitted in the IEEE 802.11 UHR standard in some cases. Further, instead of the RL-SIG, a field may be provided to allow the receiver to recognize that the PPDU is compliant with the IEEE 802.11 UHR standard. The fields of the PPDU are not necessarily arranged in the order illustrated in FIG. 5, and may include a new field not illustrated in FIG. 5.

The L-STF 501 is used for PHY frame signal detection, automatic gain control (AGC), timing detection, and the like. The L-LTF 502 is used for high-precision synchronization of frequency and time, for acquiring propagation channel information (channel state information (CSI)), and the like. The L-SIG 503 is used for transmitting control information including information about the data transmission rate and the PHY frame length.

Legacy devices that are compliant with the IEEE 802.11a/b/g/n/ax/be standards can decode the above-described various legacy fields.

The UHR PPDU further includes a universal SIG (U-SIG 505) field that is placed immediately after the RL-SIG and includes information common to standards subsequent to the IEEE 802.11be standard.

The UHR PPDU further includes a UHR-SIG (UHR-SIG 506) for transmitting control information for UHR. Each PPDU also includes an STF (UHR-STF 507) for UHR and an LTF (UHR-LTF 508) for UHR. Each PPDU includes a data field 509 and a packet extension field 510 after these control fields. The fields from the L-STF to the UHR-LTF in the UHR PPDU are referred to as the PHY preamble.

FIG. 5 illustrates a PPDU that can ensure backward compatibility as an example; however, in a case where it is not necessary to ensure backward compatibility, for example, the legacy fields may be omitted.

In this case, for example, the UHR-STF and UHR-LTF are used instead of the L-STF and L-LTF to establish synchronization. Furthermore, in this case, the UHR-STF or one of the plurality of UHR-LTFs after the UHR-SIG can be omitted.

The U-SIG 505 included in the UHR PPDU includes a U-SIG1 and a U-SIG2 necessary for receiving the PPDU, as indicated in Table 1 below.

TABLE 1

| | Bit | | Number | |
|---|---|---|---|---|
| | Position | Field | of Bits | Description |
| U-SIG1 | B0-B2 | PHY Version | 3 | Identifier for distinguishing different PHY versions |
| | | Identifier | | |
| | B3-B5 | Bandwidth | 3 | Indicates bandwidth |
| | B6 | UL/DL | 1 | Indicates whether the PPDU is for uplink (UL) or |
| | | | | downlink (DL) |
| | B7-B12 | BSS Color | 6 | Identifier for the BSS |
| | B13-B19 | TXOP | 7 | Indicates whether Dual Carrier Modulation (DCM) is |
| | | | | applied to the data field. |
| | | | | If Space-Time Block Coding (STBC) field is 0: 1 |
| | | | | (If both DCM and STBC fields are 1, neither is |
| | | | | applied) |
| | | | | If DCM is not applied: 0 |
| | B20-B22 | Multi-AP | 3 | Indicates Multi-AP group identification information |
| | | Group ID | | |
| | B23-B25 | Disregard | 3 | All bits are set to 1; the value is ignored |
| U-SIG2 | B0-B15 | Disregard | 16 | All bits are set to 1; the value is ignored |
| | B16-B19 | CRC | 4 | Cyclic Redundancy Check (CRC) of bits 0-41 in the |
| | | | | U-SIG field |
| | B20-B25 | Tail | 6 | Terminates the trellis of the convolutional decoder. |
| | | | | Set to 0. |

In Table 1, the Multi-AP Group ID field at B20 to B22 indicates the group identification information for the plurality of APs. At this time, all bits in the Multi-AP Group ID field may be set to 1 to indicate that Multi-AP communication is not performed, and other values may indicate the group identification information. According to the present example, three bits are used in the Multi-AP Group ID field, but the number of bits may be less than three or more than three. The Multi-AP Group ID field is determined when roles are determined among the plurality of APs and is shared as the network information among the plurality of APs. Each AP that performs Multi-AP communication transmits the wireless frame including the PHY preamble in which the value of the Multi-AP Group ID field is set to the same value. According to the present example, the Multi-AP Group ID field is provided in the U-SIG1, but it may be provided in other SIGs, such as the U-SIG2 and the UHR-SIG.

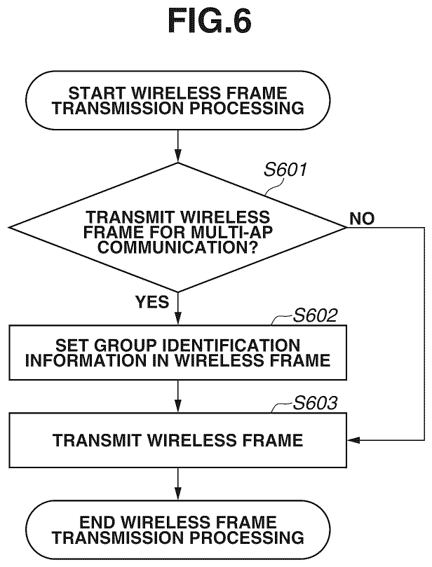

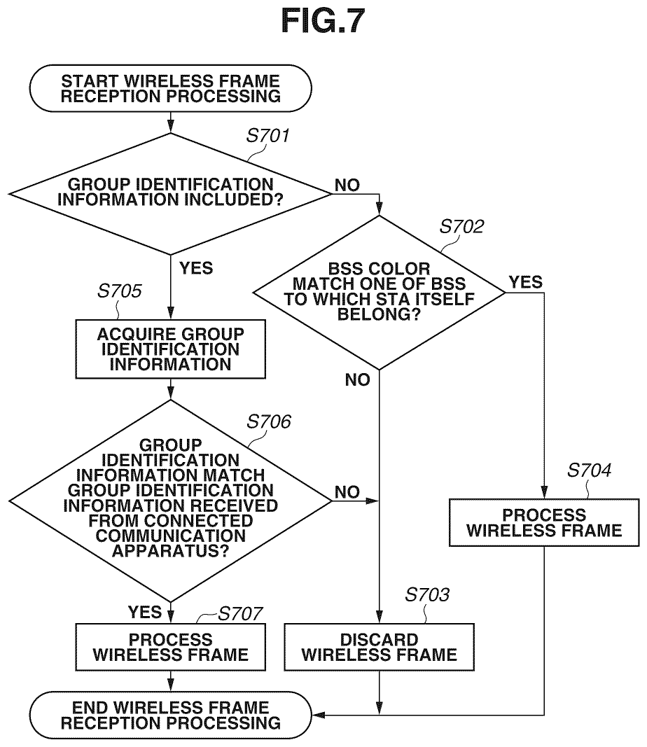

Next, the flow of processing executed by the above-described AP and STA will be described with reference to FIGS. 6 and 7.

FIG. 6 is a flowchart diagram illustrating an example of processing executed by the AP. The present processing is executed in a case where the AP transmits a wireless frame. In step S601, the AP determines whether the wireless frame to be transmitted is a wireless frame for Multi-AP communication. In a case where it is the wireless frame for Multi-AP communication (YES in step S601), in step S602, the group identification information for the plurality of APs is set in a predetermined field of the PHY preamble of the wireless frame. In step S603, the AP transmits the wireless frame. The group identification information for the plurality of APs is determined when roles are determined among the plurality of APs and is shared as the network information among the plurality of APs. In a case where the wireless frame to be transmitted by the AP is not a wireless frame for Multi-AP communication (NO in step S601), in step S603, the AP transmits the wireless frame without setting the group identification information for the plurality of APs in the predetermined field of the PHY preamble of the wireless frame, or by setting information indicating that the predetermined field of the PHY preamble does not include the group identification information for the plurality of APs.

FIG. 7 is a flowchart diagram illustrating an example of processing executed by the STA. The present processing is executed in a case where the STA receives a wireless frame from an external apparatus. In step S701, the STA determines whether the group identification information for the plurality of APs is included in the predetermined field of the PHY preamble of the received wireless frame. In a case where the group identification information for the plurality of APs is not included (NO in step S701), the STA determines that Multi-AP communication is not being performed and, in step S702, checks the value of the BSS Color field of the wireless frame. As the result, in a case where the value matches the BSS Color of the AP to which the STA itself is connected (YES in step S702), in step S704, the STA decodes the data field of the wireless frame and performs processing according to the content of the data field. In a case where the value does not match the BSS Color of the connected AP (NO in step S702), in step S703, the STA discards the wireless frame. In a case where the group identification information for the plurality of APs is included in the received wireless frame (YES in step S701), the STA determines that Multi-AP communication is being performed and, in step S705, acquires the group identification information for the plurality of APs. In step S706, the STA determines whether the group identification information for the plurality of APs acquired in step S705 matches the group identification information for the plurality of APs received from the connected AP. The group identification information for the plurality of APs acquired from the connected AP may be acquired from an Information Element included in the Beacon frame, the Probe Response frame, the Association Response frame, other management frames, and the like, or may be acquired from information included in the PHY preamble included in another wireless frame. The group identification information may be acquired, for example, from information included in the PHY preamble of a data frame rather than from a management frame. In a case where the group identification information for the plurality of APs acquired in step S705 matches the group identification information for the plurality of APs notified to the STA from the connected AP (YES in step S706), in step S707, the STA decodes the data field of the received wireless frame and performs processing according to the content of the data field. In a case where the group identification information for the plurality of APs acquired in step S705 does not match the group identification information for the plurality of APs notified from the connected AP (NO in step S706), in step S703, the STA discards the wireless frame. For example, in a case where the STA 105 receives group identification information for Multi-AP communication intended for the STA 106 or the STA 107, the information is different from the group identification information received from the connected AP, so that the STA 105 discards the wireless frame.

As described above, in the wireless frame structure of the PPDU (UHR PPDU) used in the IEEE 802.11 UHR standard, an AP that transmits data can transmits group identification information of a plurality of APs in performing Multi-AP communication to the STA. In this way, the communication apparatus can recognize the group identification information used for a plurality of other communication apparatuses to perform transmission in a coordinated manner. Accordingly, the STA can compare the group identification information with the group identification information for the plurality of APs notified from the AP with which the STA itself establishes a connection and determine whether to process or discard the received wireless frame. Thus, for example, in a case of performing Multi-AP communication, even if the BSS Color of the received wireless frame is different from the BSS Color of the AP to which the STA itself is connected, the STA can appropriately process the wireless frame without discarding it. Further, even in a case of receiving a wireless frame that does not perform Multi-AP communication, as in standards prior to the EE 802.11be standard, the STA can appropriately process the wireless frame based on the BSS Color.

The present disclosure can also be implemented by an information processing apparatus (for example, a wireless chip) that generates the above-described PHY preamble, in addition to the APs 102 to 104 and the STAs 105 to 107, which are communication apparatuses.

### Second Example

In a second example, an example is described in which a different format is used as a U-SIG field included in a UHR PPDU.

The U-SIG field included in the UHR PPDU includes a U-SIG1 and a U-SIG2 necessary for receiving the PPDU, as indicated in Table 2 below.

TABLE 2

| | Bit | | Number | |
|---|---|---|---|---|
| | Position | Field | of Bits | Description |
| U-SIG1 | B0-B2 | PHY Version | 3 | Identifier for distinguishing different PHY versions |
| | | Identifier | | |
| | B3-B5 | Bandwidth | 3 | Indicates bandwidth |
| | B6 | UL/DL | 1 | Indicates whether the PPDU is for UL or DL |
| | B7-B12 | BSS Color | 6 | Identifier for BSS |
| | | | | If Non Partial Multi-AP Group ID = 0, B7-B9 are |
| | | | | used as Multi-AP group identification information, |
| | | | | and B10-B12 are used as BSS identifiers. |
| | | | | If Non Partial Multi-AP Group ID = 1, B7-B12 are |
| | | | | used as BSS identifiers. |
| | B13-B19 | TXOP | 7 | Indicates whether Dual Carrier Modulation is applied |
| | | | | to the data field. |
| | | | | If STBC field is 0: 1 |
| | | | | (If both DCM and STBC fields are 1, neither is |
| | | | | applied) |
| | | | | If DCM is not applied: 0 |
| | B20 | Non Partial | 1 | Indicates whether to use part of the BSS Color as the |
| | | Multi-AP | | Multi-AP Group ID. |
| | | Group ID | | 0: Part of the BSS Color is used as Multi-AP group |
| | | | | identification information. |
| | | | | 1: Part of the BSS Color is not used as Multi-AP |
| | | | | group identification information. |
| | B21-B25 | Disregard | 5 | All bits are set to 1; value is ignored |
| U-SIG2 | B0-B15 | Disregard | 16 | All bits are set to 1, value is ignored |
| | B16-B19 | CRC | 4 | CRC of bits 0-41 in the U-SIG field |
| | B20-B25 | Tail | 6 | Terminates the trellis of the convolutional decoder. |
| | | | | Set to 0. |

In Table 2, the Non Partial Multi-AP Group ID field at B20 indicates whether a part of the BSS Color field at B7 to B12 is used as the group identification information for the plurality of APs. In a case where the value of the Non Partial Multi-AP Group ID is zero (0), bits B7 to B9 of the BSS Color field are used as the group identification information for the plurality of APs, and bits B10 to B12 are used for identifying the BSS. For example, the APs 103 and 104 belong to the same group, so that bits B7 to B9 of the BSS Color field in the UHT-SIG-A of the UHR PPDU transmitted by each of the APs 103 and 104 are set to the same value, whereas bits B10 to B12 are set to different values. In a case where the value of the Non Partial Multi-AP Group ID is 1, the group identification information for the plurality of APs is not included in a part of the BSS Color field, which indicates that Multi-AP communication is not performed. In the present example, the Non Partial Multi-AP Group ID field is provided in the U-SIG1; however, it may be alternatively provided in another SIG, such as a U-SIG2 and a UHR-SIG.

### Third Example

In a third example, an example is described in which a further different format is used as a U-SIG field included in a UHR PPDU.

The U-SIG field included in the UHR PPDU includes a U-SIG1 and a U-SIG2 necessary for receiving the PPDU, as indicated in Table 3 below.

TABLE 3

| | Bit | | Number | |
|---|---|---|---|---|
| | Position | Field | of Bits | Description |
| U-SIG1 | B0-B2 | PHY Version | 3 | Identifier for distinguishing different PHY versions |
| | | Identifier | | |
| | B3-B5 | Bandwidth | 3 | Indicates bandwidth |
| | B6 | UL/DL | 1 | Indicates whether the PPDU is for UL or DL |
| | B7-B12 | BSS Color | 6 | Identifier for BSS |
| | | | | If Non Partial Multi-AP Group ID = 0, B7-B9 are |
| | | | | used as the Multi-AP group identification information, |
| | | | | and B10-B12 are used as the BSS identifier. |
| | | | | If Non Partial Multi-AP Group ID = 1, B7-B12 are |
| | | | | used as the BSS identifier. |
| | B13-B19 | TXOP | 7 | Indicates whether Dual Carrier Modulation is applied |
| | | | | to the data field. |
| | | | | If STBC field is 0: 1 |
| | | | | (If both DCM and STBC fields are 1, neither is |
| | | | | applied) |
| | | | | If DCM is not applied: 0 |
| | B20 | Non Partial | 1 | Indicates whether to use part of the BSS Color as the |
| | | Multi-AP | | Multi-AP Group ID. |
| | | Group ID | | 0: Part of the BSS Color is used as Multi-AP group |
| | | | | identification information. |
| | | | | 1: Part of the BSS Color is not used as Multi-AP |
| | | | | group identification information. |
| | B21-B23 | Multi-AP | 3 | If Non Partial Multi-AP Group ID = 0, indicates |
| | | Group ID | | Multi-AP group identification information. |
| | B24- B25 | Disregard | 2 | All bits are set to 1; value is ignored |
| U-SIG2 | B0-B15 | Disregard | 16 | All bits are set to 1; value is ignored |
| | B16-B19 | CRC | 4 | CRC of bits 0-41 in the U-SIG field |
| | B20-B25 | Tail | 6 | Terminates the trellis of the convolutional decoder. |
| | | | | Set to 0. |

In Table 3, as in Table 2, the Non Partial Multi-AP Group ID field at B20 indicates whether a part of the BSS Color field at B7 to B12 is used as the group identification information for the plurality of APs. In a case where the value of the Non Partial Multi-AP Group ID is zero (0), bits B7 to B9 of the BSS Color field are used as the group identification information for the plurality of APs, and bits B10 to B12 are used for identifying the BSS. For example, the APs 103 and 104 belong to the same group, so that bits B7 to B9 of the BSS Color field in the UHT-SIG-A of the UHR PPDU transmitted by each of the APs 103 and 104 are set to the same value, whereas bits B10 to B12 are set to different values. In a case where the value of the Non Partial Multi-AP Group ID is 1, it indicates that the group identification information of the plurality of APs is not included in a part of the BSS Color field, and that bits B21 to B23 in the Multi-AP Group ID field indicate the group identification information for the plurality of APs. At this time, all bits of the Multi-AP Group ID field may be set to 1 to indicate that Multi-AP communication is not performed, and other values may be used to indicate the group identification information. According to the present example, three bits are used for the Multi-AP Group ID field; however, the number of bits may be less than three or more than three. According to the present example, the Non Partial Multi-AP Group ID field and the Multi-AP Group ID field are provided in the U-SIG1; however, they may be provided in another SIG, such as a U-SIG2 and a UHR-SIG.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The disclosure is not limited to the above-described embodiment, and various modifications and alterations may be made without departing from the spirit and scope of the disclosure. Accordingly, claims are appended in order to publicly disclose the scope of the invention.

According to the present disclosure, a communication apparatus can recognize group identification information used for enabling a plurality of other communication apparatuses to perform transmission in a coordinated manner.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A communication apparatus comprising:
at least one memory that stores a set of instructions; and
at least one processor that executes the instructions, the instructions, when executed, causing the communication apparatus to perform operations comprising:
receiving, from an external apparatus, a first wireless frame whose physical layer (PHY) preamble includes first group identification information for identifying a group for enabling a plurality of other communication apparatuses to perform transmission in a coordinated manner; and
processing the first wireless frame.

2. The communication apparatus according to claim 1, wherein the wireless frame is compliant with the Institute of Electrical and Electronics Engineers (IEEE) 802.11 standard, and the first group identification information is included in a Universal Signal (U-SIG) field of the PHY preamble.

3. The communication apparatus according to claim 2, wherein the PHY preamble includes a first field that indicates whether the first group identification information is included in the PHY preamble.

4. The communication apparatus according to claim 3, wherein the first group identification information is included in a basic service set (BSS) Color field of the U-SIG field.

5. The communication apparatus according to claim 4, wherein the PHY preamble includes a second field that indicates whether the first group identification information is included in the BSS Color field.

6. The communication apparatus according to claim 5,
wherein the communication apparatus receives, from another communication apparatus with which a connection has been established, a second wireless frame including second group identification information indicating a group for enabling a plurality of other communication apparatuses to perform transmission to the communication apparatus in a coordinated manner, and
wherein, in a case where the first group identification information matches the second group identification information, the first wireless frame is processed, and in a case where the first group identification information does not match the second group identification information, the first wireless frame is discarded.

7. A communication apparatus comprising:
at least one memory that stores a set of instructions; and
at least one processor that executes the instructions, the instructions, when executed, causing the communication apparatus to perform operations comprising:
generating a wireless frame whose physical layer (PHY) preamble includes group identification information for identifying a group for enabling the communication apparatus and a first other communication apparatus to perform transmission in a coordinated manner; and
transmitting the wireless frame to a second other communication apparatus in coordination with the first other communication apparatus.

8. The communication apparatus according to claim 7, wherein the wireless frame is compliant with the IEEE 802.11 standard, and the group identification information is included in a U-SIG field of the PHY preamble.

9. The communication apparatus according to claim 7, wherein the PHY preamble includes a first field that indicates whether the group identification information is included in the PHY preamble.

10. The communication apparatus according to claim 8, wherein the group identification information is included in a BSS Color field of the U-SIG field.

11. The communication apparatus according to claim 10, wherein the PHY preamble includes a second field that indicates whether the group identification information is included in the BSS Color field.

12. A communication method executed by a communication apparatus, the method comprising:
receiving, from an external apparatus, a first wireless frame whose physical layer (PHY) preamble includes first group identification information for identifying a group for enabling a plurality of other communication apparatuses to perform transmission in a coordinated manner; and
processing the first wireless frame.

13. A communication method executed by a communication apparatus, the method comprising:
generating a wireless frame whose physical layer (PHY) preamble includes group identification information for identifying a group for enabling the communication apparatus and a first other communication apparatus to perform transmission in a coordinated manner; and
transmitting the wireless frame to a second other communication apparatus in coordination with the first other communication apparatus.

14. A non-transitory computer readable storage medium storing a program that, when executed, causes a computer to operate as the communication device according to claim 1.
